(19) United States
(12) Patent Application Publication
(10) Pub. No.: US 2023/0169334 A1
(43) Pub. Date: Jun. 1, 2023

(54) ESTIMATION METHOD, ESTIMATION APPARATUS AND PROGRAM

(71) Applicant: NIPPON TELEGRAPH AND TELEPHONE CORPORATION, Tokyo (JP)

(72) Inventors: Yoshiaki TAKIMOTO, Tokyo (JP); Hiroyuki TODA, Tokyo (JP); Takeshi KURASHIMA, Tokyo (JP); Shuhei YAMAMOTO, Tokyo (JP)

(73) Assignee: NIPPON TELEGRAPH AND TELEPHONE CORPORATION, Tokyo (JP)

(21) Appl. No.: 17/922,320

(22) PCT Filed: May 7, 2020
(86) PCT No.: PCT/JP2020/018513

§ 371 Date: Oct. 28, 2022

(51) Int. Cl. G06N 3/08; G06N 3/0464

(52) U.S. Cl. CPC G06N 3/08; G06N 3/0464

(57) ABSTRACT

An estimation method according to an embodiment is characterized by a computer executing: inputting time series data into a first neural network model, estimating a label for the time series data, inputting an intermediate output from the first neural network model when estimating the label into a second neural network model, estimating a time series condition of the time series data, and updating a parameter of the first neural network model and a parameter of the second neural network model by using an error between the estimated label and a ground truth label for the time series data and an error between the estimated time series condition and a true time series condition of the time series data.

### TECHNICAL FIELD

The present invention relates to an estimation method, an estimation apparatus, and a program.

### BACKGROUND ART

In the related art, machine learning technology is being used to estimate labels from time series data. However, in some cases, bias may be introduced into the features of the time series data due to differences in the sampling rate or the collection method. For example, in some cases, bias may be introduced into the features of data such as sensor data or video data because the appropriate sampling rate is different depending on the circumstances. As another example, in the case where a dashboard camera is triggered when the acceleration reaches a fixed value or higher, and video or the like of several seconds before and after the trigger is collected, bias may be introduced into the features if video of 10 seconds before and 5 seconds after the trigger is collected in some cases and video of 12 seconds before and 6 seconds after the trigger is collected in other cases.

When estimating labels from time series data containing such bias, there is a problem in that the estimation accuracy may be limited. To address this problem, a process such as resampling or linear interpolation may be performed to make the frame rate consistent, trimming may be performed to make the collection methods quasi-uniform, or a sliding window may be used to account for a variety of collection methods, for example. In addition, it is also a common practice to use domain adaptation methods (for example, see Non-Patent Literature 1) and domain generalization methods (for example, see Non-Patent Literature 2).

### CITATION LIST

### Non-Patent Literature

Non-Patent Literature 1: Yaroslav Ganin, Evgeniya Ustinova, Hana Ajakan, Pascal Germain, Hugo Larochelle, Francois Laviolette, Mario Marchand, Victor Lempitsky, “Domain-Adversarial Training of Neural Networks”, arXiv:1505.07818.
Non-Patent Literature 2: Ya Li, Xinmei Tian, Mingming Gong, Yajing Liu, Tongliang Liu, Kun Zhang, and Dacheng Tao, “Deep Domain Generalization via Conditional Invariant Adversarial Networks”, ECCV 2018: Computer Vision—ECCV 2018, pp. 647-663.

### SUMMARY OF THE INVENTION

### Technical Problem

However, the information included in the time series data is reduced by the methods resampling, trimming, or using a sliding window, for example, and the accuracy is limited in some cases. As another example, with linear interpolation and the like, performing incorrect interpolation may introduce noise and limit the accuracy in some cases, while in addition, interpolation itself is difficult for data such as video data. Furthermore, in some cases, the accuracy is lowered simply by using ordinary domain adaptation methods and domain generalization methods.

An object of an embodiment of the present invention, which have been made in light of the above points, is to accurately estimate labels for time series data.

### Means for Solving the Problem

To achieve the above objective, an estimation method according to an embodiment is characterized by a computer executing a first estimation step of inputting time series data into a first neural network model and estimating a label for the time series data, a second estimation step of inputting an intermediate output from the first neural network model when estimating the label into a second neural network model and estimating a time series condition of the time series data, and an update step of using an error between the label estimated in the first estimation step and a ground truth label for the time series data and an error between the time series condition estimated in the second estimation step and a true time series condition of the time series data to update a parameter of the first neural network model and a parameter of the second neural network model.

### Effects of the Invention

Labels for time series data can be estimated accurately.

### BRIEF DESCRIPTION OF DRAWINGS

FIG. 1 is a diagram illustrating an exemplary functional configuration of an estimation apparatus according to Example 1.

FIG. 2 is a flowchart illustrating a training process and an estimation process executed by the estimation apparatus according to Example 1.

FIG. 3 is a diagram illustrating an exemplary functional configuration of an estimation apparatus according to Example 2.

FIG. 4 is a flowchart illustrating a training process and an estimation process executed by the estimation apparatus according to Example 2.

FIG. 5 is a diagram illustrating an exemplary hardware configuration of an estimation apparatus according to an Example.

### DESCRIPTION OF EMBODIMENTS

Hereinafter, an embodiment of the present invention will be described. The present embodiment will be described in terms of an estimation apparatus 10 capable of suppressing a reduction in accuracy due to chronological bias dependent on individual data within time series data when estimating labels for the time series data, and thereby estimating labels accurately. Note that the estimation apparatus 10 according to the present embodiment has a training phase of learning the parameters of a machine learning model from training data, and an estimation phase of estimating labels for time series data that is the object of estimation (hereinafter also referred to as the “time series data to be estimated”) by using the machine learning model set with the learned parameters.

<Overview of Signs and Method>

In the present embodiment, xₜ denotes data obtained at a time t (such as image data or sensor data at the time t, for example), time series conditions (such as the frequency and length of the time series data, for example) are expressed as

C={cᵢ}=ᵢ₌₁^{l} [Math. 1]

and the time series data is expressed as

X=({xₜ}ₜ₌₁^{T},C) [Math. 2].

In other words, in the present embodiment, pairs of time series data {x₁, . . . , x_{T}} and corresponding time series conditions C are treated as the “time series data”. In the following the time series data {x₁, . . . , x_{T}} is referred to as the “raw time series data”. Note that I is the number of conditions and T is the final time of the data within the raw time series data (in other words, the length of the raw time series data).

Also, y represents a label. Note that the label may be an integer value representing a category or the like, or a real (continuous) value expressing a continuous quantity of some kind.

At this time, a training data set given to the estimation apparatus 10 in the training phase is expressed as

{(Xₙ,yₙ)}ₙ₌₁^{N} [Math. 3]

where Xₙ denotes the nth time series data (hereinafter also referred to as the “training time series data”), yₙ denotes the corresponding label (ground truth label), and N denotes the number of training data. Note that Cₙ denotes the time series conditions included in the training time series data Xₙ.

The following describes a case where, when the training data set is given, the parameters of a model (machine learning model) that estimates the label y for the time series data X to be estimated are estimated by a supervised learning method. However, the use of a supervised learning method is merely an example, and in the present embodiment it is also possible to use a method such as semi-supervised learning or domain adaptation, for example. Note that any deep learning neural network model with respect to time series data (a deep learning model achieved by a neural network such as a convolutional neural network (CNN) or a recurrent neural network (RNN), for example) is usable as the machine learning model for estimating the label y for the time series data X to be estimated.

The estimation apparatus 10 according to the present embodiment (1) considers the raw time series data included in the time series data Xₙ to be time series data obtained from the domain

D_{C}_{ₙ} [Math. 4]

based on the time series conditions Cₙ, and (2) learns the parameters while applying a domain adaptation or domain generalization method. With this arrangement, when estimating the label y for the time series data X to be estimated, it is possible to use only features that do not depend on the time series conditions C.
Consequently, for example, it is possible to estimate the label y for the time series data X to be estimated without a reduction in the information used for training and estimation and without additional noise caused by preprocessing such as trimming and interpolation. For this reason, in the estimation apparatus 10 according to the present embodiment, it is possible to suppress a reduction in accuracy and achieve an accurate estimation when estimating the label y for the time series data X to be estimated.

Note that in (1) above, domains may be treated as categorical, but it is preferable to basically treat domains as continuous values because a countless number of possible domains exist. Also, in (2) above, it is possible to use any method (such as the domain adaptation method described in Non-Patent Literature 1 or the domain generalization method described in Non-Patent Literature 2 above, for example) insofar as the method is applicable to deep learning as a domain adaptation or domain generalization technique.

### Example 1

Hereinafter, Example 1 of the present embodiment will be described. As an example, Example 1 supposes a case where acceleration data collected from a smartwatch is used to estimate the movement of a person wearing the smartwatch. Here, it is assumed that the frequency at which the acceleration data is collected (that is, the frequency of the raw time series data) is different depending on factors such as the type of smartwatch and settings. In addition, the acceleration data is divided up and assigned a ground truth label yₙ by a sliding window having a fixed time step (such as 3 seconds, for example), and is paired with the time series conditions Cₙ to obtain the training time series data Xₙ. During estimation, acceleration data likewise is divided up by a sliding window of fixed time and paired with the time series conditions C to obtain the time series data X to be estimated.

In other words, xₜ is the acceleration data at the time t, Cₙ={c_{n,1}} is the time series condition included in the training time series data Xₙ, and yₙ is the corresponding ground truth label. Here, c_{n,1} is the frequency of the acceleration data included in the training time series data Xₙ. Also, T is the time step (such as 3 seconds, for example) of the sliding window. The time series data X to be estimated is similar to the training time series data Xₙ except that ground truth labels are not assigned, and is expressed as X=({x₁, . . . , x_{T}}, C}. Note that the labels are values denoting movements such as “walking” and “running”, for example.

Here, Example 1 describes a case where a deep learning model based on a CNN is adopted as the machine learning model for estimating the label y for the time series data X to be estimated, and parameters are learned while applying a domain adaptation method according to Domain-Adversarial Training of Neural Networks (DANN) described in Non-Patent Literature 1 above.

<Functional Configuration>

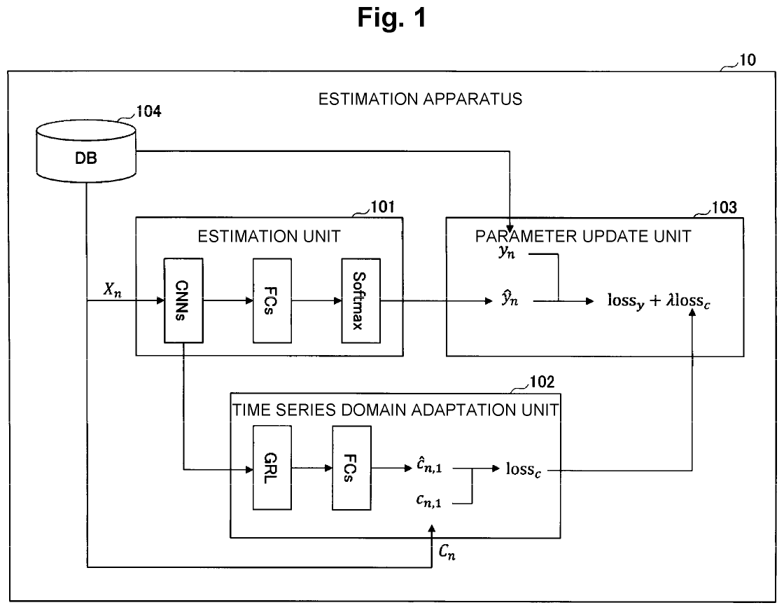

First, a functional configuration of the estimation apparatus 10 according to Example 1 will be described with reference to FIG. 1. FIG. 1 is a diagram illustrating an example of the functional configuration of the estimation apparatus 10 according to Example 1.

As illustrated in FIG. 1, the estimation apparatus 10 according to Example 1 includes an estimation unit 101, a time series domain adaptation unit 102, a parameter update unit 103, and a database (DB) 104.

The DB 104 stores data such as a training data set {(X₁, y₁), . . . , (X_{N}, y_{N})} and the time series data X to be estimated. Information such as parameters to be learned may also be stored in the DB 104.

In the training phase, the estimation unit 101 accepts the training time series data Xₙ as input, and estimates the corresponding label

ŷₙ [Math. 5].

Note that in the following, the sign “\hat{ }” denoting the estimation result in the text of the specification is written immediately in front of the character rather than above the character for convenience. For example, the estimation result of the label y is denoted “\hat{ }y”.

Also, in the estimation phase, the estimation unit 101 accepts the time series data X to be estimated as input, and estimates the corresponding label \hat{ }y.

The estimation unit 101 according to Example 1 is achieved by a neural work model containing one or more convolutional neural network layers (CNNs), one or more fully connected neural network layers (FCs), and an output layer using the softmax function for the activation function. The estimation unit 101 performs a nonlinear transform treating the training time series data Xₙ (or the time series data X to be estimated) as a matrix (tensor), and thereby estimates the label \hat{ }yₙ (or the label \hat{ }y). Note that the matrix (tensor) may have any shape, and it is conceivable to define the matrix as the number of sensor classes (that is, the number of elements in the data xₜ) x the number of the time series (that is, T), or treat channel directions as the number of sensor classes and define the matrix as the number of sensor classes×1×the number of the time series, for example. Also, any type of kernel (filter) may be used in the convolutional neural network layers.

In the training phase, the time series domain adaptation unit 102 treats the output from the convolutional neural network layers achieving the estimation unit 101 as input, and estimates the time series condition, namely the frequency \hat{ }c_{n,1}. In addition, the time series domain adaptation unit 102 treats the frequency c_{n,1} that is the time series condition Cₙ included in the training time series data Xₙ as input, and calculates the error loss_{c} between the frequency c_{n,1} and the corresponding estimation value, namely the frequency \hat{ }c_{n,1}. Note that the output from the convolutional neural network layers achieving the estimation unit 101 is a feature that does not depend on the time context.

Here, the time series domain adaptation unit 102 according to Example 1 is achieved with a neural network model containing a gradient reversal layer (GRL) and one or more fully connected neural network layers. The time series domain adaptation unit 102 estimates the frequency \hat{ }c_{n,1} by performing a nonlinear transform on the output from the convolutional neural network layers achieving the estimation unit 101. Note that the GRL is a layer that functions as the identity function during forward propagation, and as a function that reverses the sign during backpropagation.

In the training phase, the parameter update unit 103 accepts the error loss_{c} between the label \hat{ }yₙ and the ground truth label yₙ as input, uses the cross-entropy to calculate the error loss_{y} between the label \hat{ }yₙ and the ground truth label yₙ, and updates the parameters using the total error loss_{y}+λloss_{c}. In other words, the parameter update unit 103 updates the parameters by backpropagating the total error loss_{y}+λloss_{c} so as to minimize the total error according to a known optimization method. Note that the parameters to be learned are the parameters of the neural network model achieving the estimation unit 101 and the parameters of the neural network model achieving the time series domain adaptation unit 102. Also, λ is a hyper parameter for adjusting the scale between the error loss_{y} and the error loss_{c}.

<Flows of Processes>

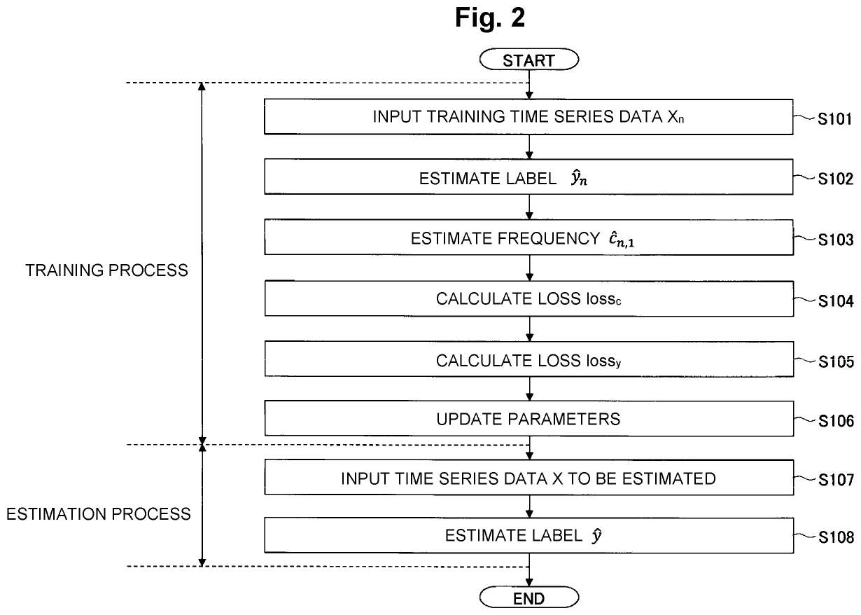

Next, the flow of a training process executed in the training phase and the flow of an estimation process executed in the estimation phase by the estimation apparatus 10 according to Example 1 will be described with reference to FIG. 2. FIG. 2 is a flowchart illustrating the training process and the estimation process executed by the estimation apparatus according to Example 1. Note that in FIG. 2, steps S101 to S106 are the training process, and steps S107 and S108 are the estimation process.

The following steps S101 to S106 are executed repeatedly using any optimization method (such as Adam or stochastic gradient descent (SGD), for example) until a predetermined end condition is satisfied. Note that the predetermined end condition is satisfied when, for example, the number of repetitions reaches or exceeds a predetermined number.

First, the estimation unit 101 accepts the training time series data Xₙ as input (step S101). Next, the estimation unit 101 estimates the label \hat{ }yₙ for the training time series data Xₙ (step S102).

Next, the time series domain adaptation unit 102 accepts the output from the convolutional neural network layers when estimating the label \hat{ }yₙ in step S102 above as input, and estimates the time series condition, namely \hat{ }c_{n,1} (step S103).

Next, the time series domain adaptation unit 102 accepts the frequency c_{n,1} that is the time series condition Cₙ included in the training time series data Xₙ inputted in step S101 above as input, and calculates the error loss_{c} between the frequency c_{n,1} and the frequency \hat{ }c_{n,1} estimated in step S103 above (step S104).

Next, the parameter update unit 103 accepts the label yₙ corresponding to the training time series data Xₙ inputted into step S101 above as input, and calculates the error loss_{y} between the label yₙ and the label \hat{ }yₙ estimated in step S102 above (step S105).

Thereafter, the parameter update unit 103 uses the error loss_{c} calculated in step S104 above and the error loss_{y} calculated in step S105 above to calculate the total error loss_{y}+λloss_{c}, and updates the parameters by backpropagating the total error so as to minimize the total error according to a known optimization method (step S106). With this arrangement, the parameters of the neural network model achieving the estimation unit 101 (and the neural network model achieving the time series domain adaptation unit 102) are learned.

The following describes the case of estimating the label y for a certain time series data X to be estimated, but in the case of estimating respective labels y for each of a plurality of time series data X to be estimated, it is sufficient to execute steps S107 and S108 repeatedly with respect to each time series data X to be estimated.

First, the estimation unit 101 accepts the time series data X to be estimated as input (step S107). Next, the estimation unit 101 estimates the label \hat{ }y for the time series data X to be estimated (step S108). Note that although Example 1 describes the case where the training process and the estimation process are executed by the same device (the estimation apparatus 10), the configuration is not limited thereto, and the training process and the estimation apparatus may also be executed by different devices, for example.

### Example 2

Hereinafter, Example 2 of the present embodiment will be described. As an example, Example 2 supposes a case of estimating the driving status of a vehicle by using video and acceleration data (hereinafter also referred to as “event data”) collected from a dashboard camera. The timing at which event data is collected from the dashboard camera is assumed to be triggered when a certain acceleration or higher is reached, and event data from only a dozen or so seconds before and after the trigger is collected. At this time, properties such as the collection duration before and after the trigger and the frequency of the event data to be collected are assumed to be different depending on factors such as the type of dashboard camera and settings. Also, it is assumed that ground truth labels are assigned to the individual event data and paired with the time series conditions Cₙ to obtain the training time series data Xₙ. On the other hand, event data with unknown labels are paired with time series conditions C to obtain the time series data X to be estimated.

In other words, provided that xₜ^{image} is the image data and xₜ^{sensor} is the acceleration data at a time t, the event data is expressed as xₜ=(xₜ^{image}, xₜ^{sensor}). Additionally, Cₙ={c_{n,1}, c_{n,2}, c_{n,3}} are the time series conditions included in the training time series data Xₙ, and yₙ is the corresponding ground truth label. In the above, c_{n,1} is the frequency of the event data included in the training time series data Xₙ, c_{n,2} is the collection duration before the trigger, and c_{n,3} is the collection duration after the trigger. Also, Tₙ is the length of the raw time series data (that is, the event data) included in the training time series data Xₙ. The time series data X to be estimated is similar to the training time series data Xₙ except that ground truth labels are not assigned, and is expressed as X=({x₁, . . . , x_{T}}, C}.

Note that the label is a value representing a driving status such as “traffic accident”, “near-miss incident”, and “incident involving pedestrian”, for example. Also, Tₙ and T above are calculated from the time series conditions Cₙ and C, respectively.

Here, Example 2 describes a case where a deep learning model based on a CNN and an RNN is adopted as the machine learning model for estimating the label y for the time series data X to be estimated, and parameters are learned while applying a domain adaptation method according to DANN described in Non-Patent Literature 1 above.

<Functional Configuration>

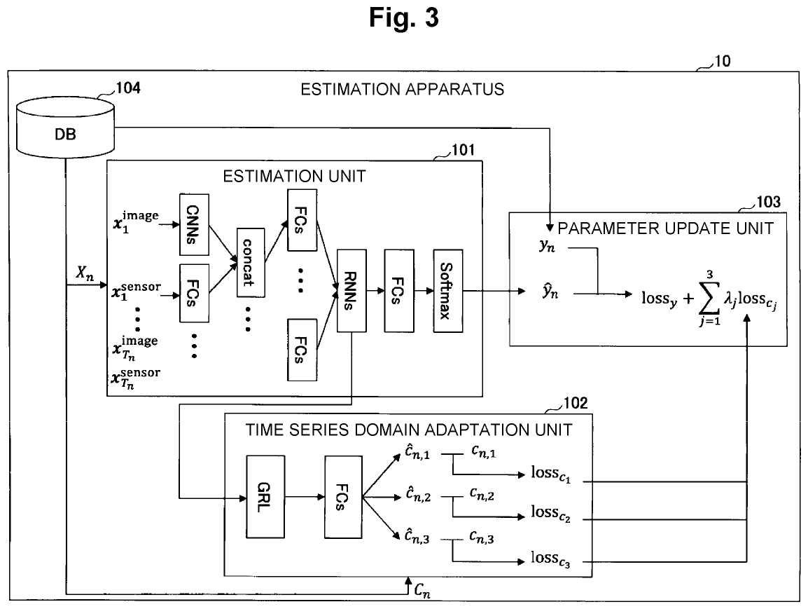

First, a functional configuration of the estimation apparatus 10 according to Example 2 will be described with reference to FIG. 3. FIG. 3 is a diagram illustrating an example of the functional configuration of the estimation apparatus 10 according to Example 2.

As illustrated in FIG. 3, the estimation apparatus 10 according to Example 2 includes an estimation unit 101, a time series domain adaptation unit 102, a parameter update unit 103, and a DB 104.

The DB 104 stores data such as a training data set {(X₁, y₁), . . . , (X_{N}, y_{N})} and the time series data X to be estimated. Information such as parameters to be learned may also be stored in the DB 104.

The estimation unit 101 accepts the training time series data Xₙ as input, and estimates the corresponding label \hat{ }yₙ. Also, in the estimation phase, the estimation unit 101 accepts the time series data X to be estimated as input, and estimates the corresponding label \hat{ }y.

Here, the estimation unit 101 according to Example 2 is achieved by a neural work model containing Tₙ convolutional neural network layers (CNN) into which the image data is inputted and Tₙ fully connected neural network layers (FCs) into which the acceleration data is inputted, a layer (concat) that concatenates the output from the t-th convolutional neural network layer and the output from the t-th fully connected neural network layer, Tₙ fully connected neural network layers in which the concatenated results are inputted, recurrent neural network layers (RNNs), fully connected neural network layers (FCs), and an output layer using the softmax function for the activation function. Note that in the first layer, the image data xₜ^{image} at the time t is inputted into the t-th convolutional neural network layer, and the acceleration data Xₜ^{sensor} at the time t is inputted into the t-th fully connected neural network layer. The estimation unit 101 treats the image data xₜ^{image} and the acceleration data xₜ^{sensor} as a vector or a matrix (tensor) for input into the convolutional neural network layers and the fully connected neural network layers, respectively, and performs a nonlinear transform to estimate the label \hat{ }yₙ (or the label \hat{ }y). Note that, like Example 1, the matrix (tensor) may have any shape, and any type of kernel (filter) may be used in the convolutional neural network layers.

In the training phase, the time series domain adaptation unit 102 accepts the output from the recurrent neural network layers achieving the estimation unit 101 as input, and estimates the time series conditions, namely the frequency \hat{ }c_{n,1}, the collection duration \hat{ }c_{n,2} before the trigger, and the collection duration \hat{ }c_{n,3} after the trigger. In addition, the time series domain adaptation unit 102 accepts the time series conditions Cₙ included in the training time series data Xₙ, namely the frequency c_{n,1}, the collection duration c_{n,2} before the trigger, and the collection duration c_{n,3} after the trigger as input, and calculates the error

loss_{c}_{₁} [Math. 6]

between the frequency c_{n,1} and the corresponding estimation value of the frequency \hat{ }c_{n,1}, the error

loss_{c}_{₂} [Math. 7]

between the collection duration c_{n,2} before the trigger and the corresponding estimation value of the collection duration \hat{ }c_{n,2} before the trigger, and the error

loss_{c}_{₃} [Math. 8]

between the collection duration c_{n,3} after the trigger and the corresponding estimation value of the collection duration \hat{ }c_{n,3} after the trigger. Note that the output from the recurrent neural network layers achieving the estimation unit 101 is a feature that does not depend on the time context.

Here, the time series domain adaptation unit 102 according to Example 2 is achieved with a neural network model containing a GRL and one or more fully connected neural network layers. By performing a nonlinear transform on the output from the recurrent neural network layers achieving the estimation unit 101, the time series domain adaptation unit 102 estimates the frequency \hat{ }c_{n,1}, the collection duration \hat{ }c_{n,2} before the trigger, and the collection duration \hat{ }c_{n,3} after the trigger.

In the training phase, the parameter update unit 103 accepts the error between the label \hat{ }yₙ and the ground truth label yₙ calculated by the time series domain adaptation unit 102 as input, uses the cross-entropy to calculate the error loss_{y} between the label \hat{ }yₙ and the ground truth label yₙ, and updates the parameters using the total error

$${loss}_{y} + {\sum }_{j = 1}^{3} {λ}_{j} {loss}_{{c}_{j}} \qquad [ Math . 9 ]$$

In other words, the parameter update unit 103 updates the parameters by backpropagating the total error so as to minimize the total error according to a known optimization method. Note that the parameters to be learned are the parameters of the neural network model achieving the estimation unit 101 and the parameters of the neural network model achieving the time series domain adaptation unit 102. Also, λ₁, λ₂, and λ₃ are hyper parameters for adjusting the scale between the error loss_{y} and the error calculated by the time series domain adaptation unit 102.

<Flows of Processes>

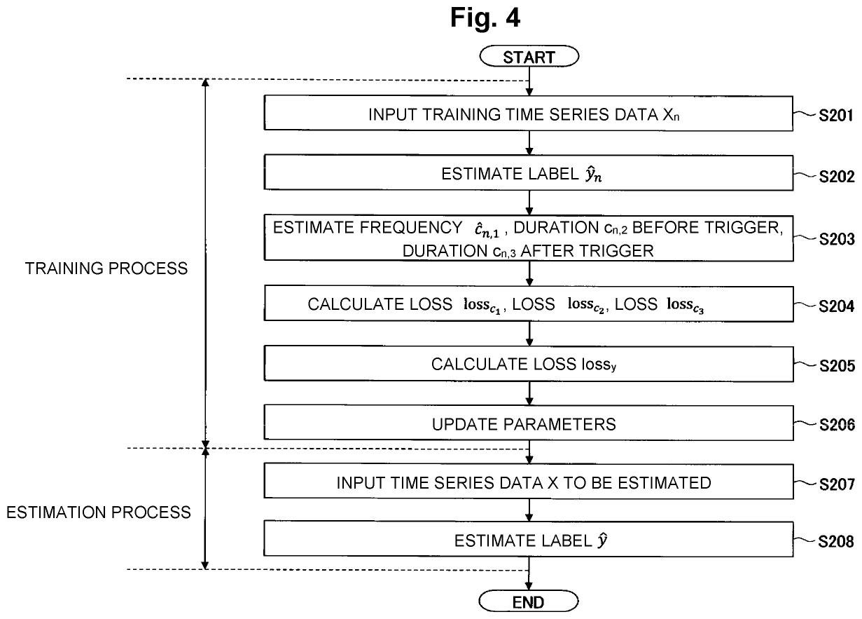

Next, the flow of a training process executed in the training phase and the flow of an estimation process executed in the estimation phase by the estimation apparatus 10 according to Example 2 will be described with reference to FIG. 4. FIG. 4 is a flowchart illustrating the training process and the estimation process executed by the estimation apparatus according to Example 1. Note that in FIG. 4, steps S201 to S206 are the training process, and steps S207 and S208 are the estimation process.

The following steps S201 to S206 are executed repeatedly using any optimization method (such as Adam or SGD, for example) until a predetermined end condition is satisfied. Note that the predetermined end condition is satisfied when, for example, the number of repetitions reaches or exceeds a predetermined number.

First, the estimation unit 101 accepts the training time series data Xₙ as input (step S201).

Next, the estimation unit 101 estimates the label \hat{ }yₙ for the training time series data Xₙ (step S202).

Next, the time series domain adaptation unit 102 accepts the output from the recurrent neural network layers when estimating the label \hat{ }yₙ in step S102 above as input, and estimates the time series conditions, namely the frequency \hat{ }c_{n,1}, the collection duration \hat{ }c_{n,2} before the trigger, and the collection duration \hat{ }c_{n,3} after the trigger (step S203).

Next, the time series domain adaptation unit 102 accepts the time series conditions included in the training time series data Xₙ inputted in step S201 above, namely the frequency c_{n,1}, the collection duration c_{n,2} before the trigger, and the collection duration c_{n,3} after the trigger as input, and respectively calculates the error with respect to each estimation value estimated in step S203 above (step S204).

Next, the parameter update unit 103 accepts the label yₙ corresponding to the training time series data Xₙ inputted into step S201 above as input, and calculates the error loss_{y} between the label yₙ and the label \hat{ }yₙ estimated in step S202 above (step S205).

Thereafter, the parameter update unit 103 uses each error calculated in step S204 above and the error loss_{y} calculated in step S205 above to calculate the total error

$${loss}_{y} + {\sum }_{j = 1}^{3} {λ}_{j} {loss}_{{c}_{j}} \qquad [ Math . 10 ]$$

and updates the parameters by backpropagating the total error so as to minimize the total error according to a known optimization method (step S206). With this arrangement, the parameters of the neural network model achieving the estimation unit 101 (and the neural network model achieving the time series domain adaptation unit 102) are learned.

The following describes the case of estimating the label y for a certain time series data X to be estimated, but in the case of estimating respective labels y for each of a plurality of time series data X to be estimated, it is sufficient to execute steps S207 and S208 repeatedly with respect to each time series data X to be estimated.

First, the estimation unit 101 accepts the time series data X to be estimated as input (step S207). Next, the estimation unit 101 estimates the label \hat{ }y for the time series data X to be estimated (step S208). Note that although Example 2 describes the case where the training process and the estimation process are executed by the same device (the estimation apparatus 10), the configuration is not limited thereto, and the training process and the estimation apparatus may also be executed by different devices, for example.

<Hardware Configuration>

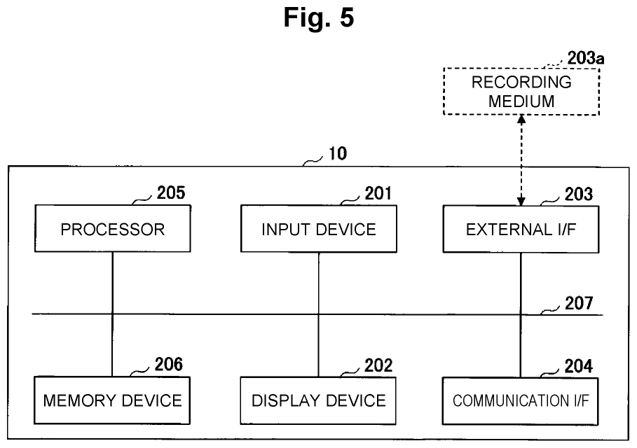

Lastly, a hardware configuration of the estimation apparatus 10 according to Examples 1 and 2 will be described with reference to FIG. 5. FIG. 5 is a diagram illustrating an example of the hardware configuration of the estimation apparatus 10 according to an Example.

As illustrated in FIG. 5, the estimation apparatus 10 according to Examples 1 and 2 is achieved by a typical computer or computer system, and includes an input device 201, a display device 202, an external I/F 203, a communication I/F 204, a processor 205, and a memory device 206. The hardware components are communicably interconnected through a bus 207.

The input device 201 is device such as a keyboard and mouse or a touch panel, for example. The display device 202 is a device such as a display, for example. Note that the estimation apparatus 10 may also not include at least one of the input device 201 or the display device 202.

The external I/F 203 is an interface with an external device such as a recording medium 203a. The estimation apparatus 10 is capable of operations such as reading from and writing to the recording medium 203a through the external I/F 203. In the recording medium 203a, one or more programs for achieving each functional unit (estimation unit 101, time series domain adaptation unit 102, and parameter update unit 103) included in the estimation apparatus 10 are stored, for example. Note that the recording medium 203a may be a medium such as a Compact Disc (CD), a Digital Versatile Disc (DVD), a Secure Digital (SD) memory card, or a Universal Serial Bus (USB) memory card, for example.

The communication I/F 204 is an interface for connecting the estimation apparatus 10 to a communication network. Note that the one or more programs achieving each functional unit included in the estimation apparatus 10 may also be acquired (downloaded) from a device such as a predetermined server device through the communication I/F 204.

The processor 205 is any of various computational devices such as a central processing unit (CPU) or a graphics processing unit (GPU), for example. Each functional unit included in the estimation apparatus 10 is achieved by a process executed by the processor 205 according to the one or more programs stored in the memory device 206, for example.

The memory device 206 is any of various storage devices such as a hard disk drive (HDD), a solid-state drive (SSD), random access memory (RAM), read-only memory (ROM), or flash memory, for example. The DB 104 included in the estimation apparatus 10 is achievable by the memory device 206, for example.

By including the hardware configuration illustrated in FIG. 5, the estimation apparatus 10 according to Examples 1 and 2 is capable of achieving the training process and the estimation process described above. Note that the hardware configuration illustrated in FIG. 5 is an example, and the estimation apparatus 10 may also have another hardware configuration. For example, the estimation apparatus 10 may also include a plurality of processors 205 and may also include a plurality of memory devices 206.

The present invention is not limited to the embodiment specifically disclosed above, and various modifications, alterations, combinations with known technologies, and the like are possible without departing from the content of the claims.

### REFERENCE SIGNS LIST

10 estimation apparatus
101 estimation unit
102 time series domain adaptation unit
103 parameter update unit
104 DB
201 input device
202 display device
203 external I/F
203a recording medium
204 communication I/F
205 processor
206 memory device

1. An estimation method characterized by a computer executing:
inputting time series data into a first neural network model;
estimating a label for the time series data;
inputting an intermediate output from the first neural network model when estimating the label into a second neural network model;
estimating a time series condition of the time series data; and
updating a parameter of the first neural network model and a parameter of the second neural network model by using an error between the estimated label and a ground truth label for the time series data and an error between the estimated time series condition and a true time series condition of the time series data.

2. The estimation method according to claim 1, wherein
an output from a convolutional neural network layer or an output from a recurrent neural network layer included in the first neural network model when estimating the label is treated as the intermediate output to be inputted into the second neural network model.

3. The estimation method according to claim 1, wherein
the time series condition includes at least one of a frequency of the time series data or a duration before, after, or before and after a time point treated as a reference when collecting the time series data.

4. The estimation method according to claim 1, wherein
the second neural network model is a neural network model achieving domain adaptation or domain generalization.

5. An estimation apparatus comprising:
a processor; and
a memory storing program instructions that cause the processor to:
accept time series data into a first neural network model
estimate a label for the time series data;
accept an intermediate output from the first neural network model when estimating the label into a second neural network model
estimate a time series condition of the time series data; and
update a parameter of the first neural network model and a parameter of the second neural network model by using an error between the estimated label and a ground truth label for the time series data and an error between the estimated time series condition and a true time series condition of the time series data.

6. A non-transitory computer-readable storage medium that stores therein a program causing a computer to execute the estimation method of claim 1.
